(19) United States
(12) Patent Application Publication
(10) Pub. No.: US 2024/0397008 A1
(43) Pub. Date: Nov. 28, 2024

(54) IMAGE SCANNING DEVICE AND IMAGE FORMING DEVICE

(71) Applicant: SHARP KABUSHIKI KAISHA, Sakai City (JP)

(72) Inventors: SHOHICHI FUKUTOME, Sakai City (JP); MAKOTO HIGUCHI, Sakai City (JP)

(21) Appl. No.: 18/670,622

(22) Filed: May 21, 2024

(30) Foreign Application Priority Data
May 26, 2023 (JP) 2023-086942

(51) Int. Cl. H04N 1/00; H04N 1/031; H04N 1/401

(52) U.S. Cl. CPC H04N 1/00888; H04N 1/00588; H04N 1/00904; H04N 1/0096; H04N 1/031; H04N 1/401; H04N 1/00978

(57) ABSTRACT

When scanning a document, an image scanning device conveys the document toward an image scanning position in a power supply stop state in which power supply to an electronic component is stopped, sets a power supply state in which power is supplied to the electronic component before scanning the document at the image scanning position, scans the document at the image scanning position in the power supply state, and sets the power supply stop state after scanning the document at the image scanning position.

### TECHNICAL FIELD

The disclosure relates to an image scanning device including an image scanning sensor including a substrate provided with a plurality of scanning elements and electronic components, and an image forming device such as a copying machine or a multifunction peripheral.

### BACKGROUND ART

As an image scanning device, for example, there is an image scanning device that includes an image scanning sensor including a substrate provided with a plurality of scanning elements and electronic components provided, conveys a document to be scanned by the image scanning sensor toward an image scanning position, and scans the document conveyed to the image scanning position by the image scanning sensor.

### SUMMARY

### Technical Problem

In such an image scanning device, when continuously scanning a large number of documents, the temperature of the image scanning sensor increases due to continuous use of the image scanning sensor, and there is inconvenience of occurrence of density unevenness in a formed image.

This will be described below by taking, as an example, a case where for example, a contact image sensor is used as the image scanning sensor and a semiconductor IC chip is used as the electronic component.

FIG. 13 is a front view schematically illustrating an internal configuration of an example of an image scanning unit 220. FIG. 14A is a front view of an example of an image scanning sensor 210 viewed from a first side in a main scanning direction X. FIG. 14B is a plan view of an example of the image scanning sensor 210 viewed from a scanning element placement side surface 211a side of a substrate 211. FIG. 15A is a graph showing each output value of a scanning element unit 212 in the image scanning sensor 210 when light sources 221 and 221 are not emitting light at an initial stage before shading correction is performed. FIG. 15B is a graph showing each output value of the scanning element unit 212 in the image scanning sensor 210 when the light sources 221 and 221 are not emitting light after a temperature rise when a plurality of documents G to G are continuously scanned before the shading correction.

As shown in FIG. 13, the image scanning unit 220 includes the light sources 221 and 221, a condenser lens array 222, and the image scanning sensor 210. The image scanning unit 220 irradiates the document G with the emission light La and La emitted from the light sources 221 and 221, respectively, and scans reflected light Lb reflected from the document G by the scanning element unit 212 via the condenser lens array 222. The condenser lens array 222 condenses the reflected light Lb (image light) reflected from the document G on the scanning element unit 212 in the image scanning sensor 210. The image scanning sensor 210 photoelectrically converts the reflected light Lb received by the scanning element unit 212 through the condenser lens array 222 and outputs image data. The scanning element unit 212 includes a plurality of scanning elements 212a to 212a arranged side by side on the substrate 211 along the main scanning direction X.

As illustrated in FIGS. 13 to 14B, the image scanning sensor 210 has a scanning element region α (see FIG. 14B) that is a region in which the plurality of scanning elements 212a to 212a are arranged side by side in the main scanning direction X on the scanning element placement side surface 211a of the substrate 211 on which the plurality of scanning elements 212a to 212a are disposed. In this example, the electronic component provided on the substrate 211 is a semiconductor IC chip 213. For example, the semiconductor IC chip 213 may be provided on a scanning element corresponding region β (see FIG. 14B) corresponding to the scanning element region α on an opposite surface 211b opposite to the scanning element placement side surface 211a of the substrate 211 in the image scanning sensor 210 or at a predetermined electronic component placement location βa (see FIG. 14B) near the scanning element corresponding region β. In this example, the semiconductor IC chip 213 is provided at the electronic component placement location βa on the scanning element corresponding region β, and the semiconductor IC chip 213 is provided with a heat dissipation member 214 (heat dissipation pad) (see FIG. 14A).

In such an image scanning sensor 210, as shown in FIG. 15A, when the light sources 221 and 221 do not emit light in the initial stage before the shading correction, each of output values of the scanning elements 212a to 212a is shown.

On the other hand, even after the shading correction, when the plurality of documents G to G (for example, a large number of documents exceeding 100 sheets) are continuously scanned, the temperature of the semiconductor IC chip 213 in the substrate 211 increases. As a result, on the opposite surface 211b opposite to the substrate 211 in the image scanning sensor 210, the temperature of the electronic component placement location βa in the scanning element corresponding region β is higher than that of the other region βb, and the temperature of the scanning elements 212a to 212a near the electronic component placement location βa is higher than that of the scanning elements 212a to 212a and 212a to 212a in the other regions βb and βb, respectively. Then, the output values of the scanning elements 212a to 212a (see FIG. 15A) when the light sources 221 and 221 are not emitting light fluctuate as shown in FIG. 15B. Thus, density unevenness in a formed image occurs between an image near the electronic component placement location βa and an image in a location away from the electronic component placement location βa.

In this regard, there is a configuration in which dimming control for reducing a light amount of a light source unit is performed in a gap portion between recording media which are continuously conveyed.

However, in the above-described configuration, although the dimming control for reducing the light amount of the light source unit is performed between the recording media, the problem caused by the temperature rise of the electronic component on the substrate is not dealt with at all.

Thus, it is an object of the disclosure to provide an image scanning device and an image forming device capable of suppressing occurrence of density unevenness in a formed image between the image near the electronic component placement location and the image in the location away from the electronic component placement location.

### Solution to Problem

In order to solve the problem, an image scanning device according to the disclosure includes an image scanning sensor including a substrate provided with a plurality of scanning elements and electronic components, and conveys a document toward an image scanning position scanned by the image scanning sensor, and scans the document conveyed to the image scanning position by the image scanning sensor, and the image scanning device includes a power supply controller that controls supply of power to the electronic component in the image scanning sensor, when scanning the document, conveys the document toward the image scanning position in a power supply stop state in which power supply to the electronic component is stopped by the power supply controller, sets a power supply state in which power is supplied to the electronic component by the power supply controller before scanning the document at the image scanning position, scans the document at the image scanning position in the power supply state, and sets the power supply stop state after scanning the document at the image scanning position.

An image forming device according to the disclosure is an image forming device including the image scanning device according to the disclosure.

### Advantageous Effects of Invention

According to the disclosure, occurrence of density unevenness in a formed image between an image near an electronic component placement location and an image in a location away from the electronic component placement location can be suppressed.

### BRIEF DESCRIPTION OF DRAWINGS

FIG. 1 is a cross-sectional view illustrating an image forming device including an image scanning device according to the present embodiment.

FIG. 2 is a plan view of an image scanner illustrated in FIG. 1 viewed from above.

FIG. 3A is a cross-sectional view of an image scanning device portion of the image forming device viewed from a front side.

FIG. 3B is a cross-sectional view of the image scanning device portion of the image forming device viewed from a side surface side.

FIG. 4 is a schematic cross-sectional view of an image scanning sensor of the image scanning device.

FIG. 5 is a system block diagram illustrating an example of a schematic configuration of the image forming device.

In FIG. 6, upper diagram is a timing chart showing a supply timing at which power is supplied to a semiconductor IC chip in scanning control of a first document, and a lower diagram is a timing chart showing a supply timing at which power is supplied to the semiconductor IC chip in scanning control of a second and subsequent documents.

FIG. 7A is a front view schematically illustrating a state in which a document is scanned by a first image scanning unit.

FIG. 7B is a front view schematically illustrating a state in which a document is scanned by a second image scanning unit.

FIG. 8 is a flowchart of an example of scanning control at start-up time in first image scanning control by a first image scanning sensor.

FIG. 9 is a flowchart of an example of scanning control at the time of a document fixed scanning operation in the first image scanning control by the first image scanning sensor.

FIG. 10 is a flowchart of an example of scanning control at the time of a document moving scanning operation of a front surface in the first image scanning control by the first image scanning sensor.

FIG. 11 is a flowchart of an example of scanning control at start-up time in second image scanning control by a second image scanning sensor.

FIG. 12 is a flowchart of an example of scanning control at the time of the document moving scanning operation of a back surface in the second image scanning control by the second image scanning sensor.

FIG. 13 is a front view schematically illustrating an internal configuration of an example of the image scanning unit.

FIG. 14A is a front view of an example of the image scanning sensor viewed from a first side in a main scanning direction.

FIG. 14B is a plan view of an example of the image scanning sensor viewed from the scanning element placement side surface side.

FIG. 15A is a graph showing each output value of the scanning element unit in the image scanning sensor when a light source is not emitting light at an initial stage after shading correction is performed.

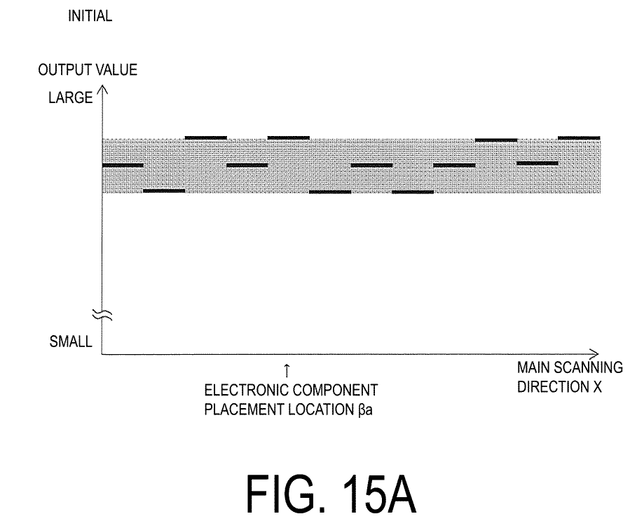

FIG. 15B is a graph showing each output value of the scanning element unit in the image scanning sensor when the light source is not emitting light after a temperature rise in continuously scanning a plurality of documents after the shading correction.

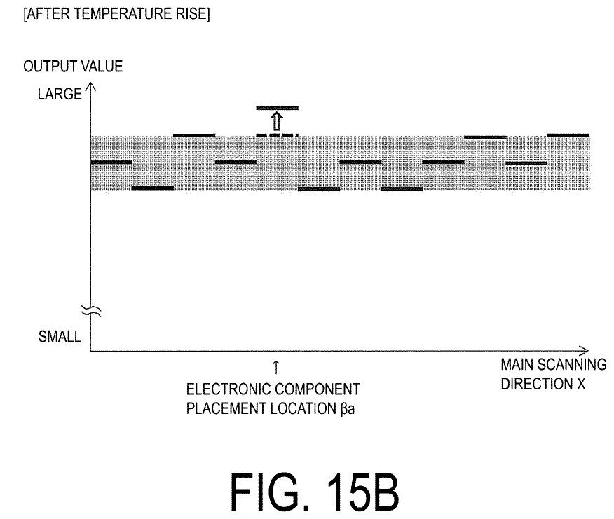

### DESCRIPTION OF EMBODIMENTS

An embodiment according to the disclosure will be described below with reference to the drawings. In the following description, the same components are denoted by the same reference signs. The names and functions of the components are also the same. Accordingly, detailed descriptions are not repeated.

### Image Forming Device

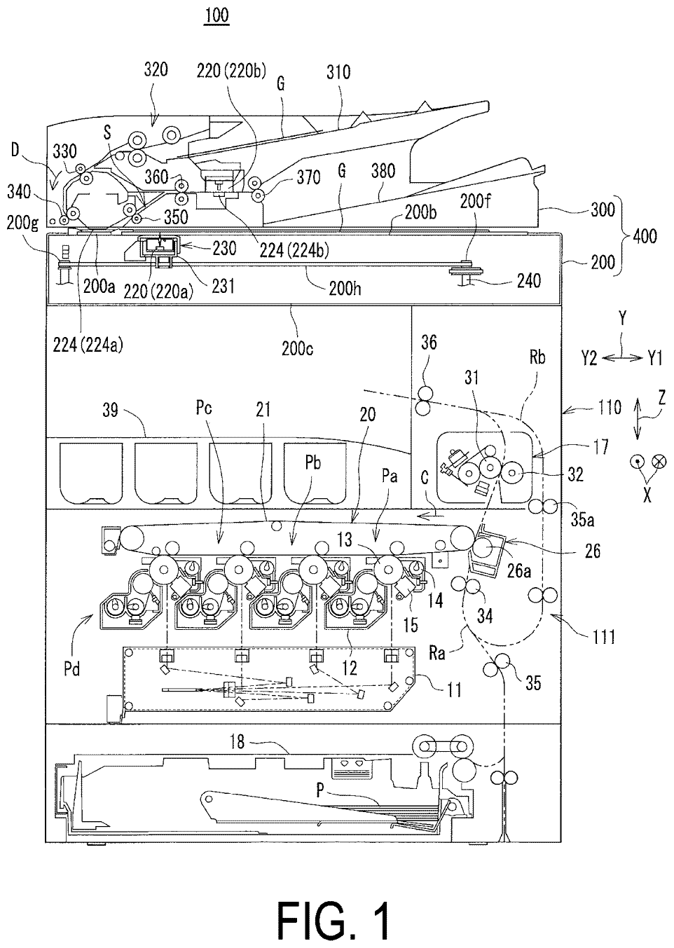

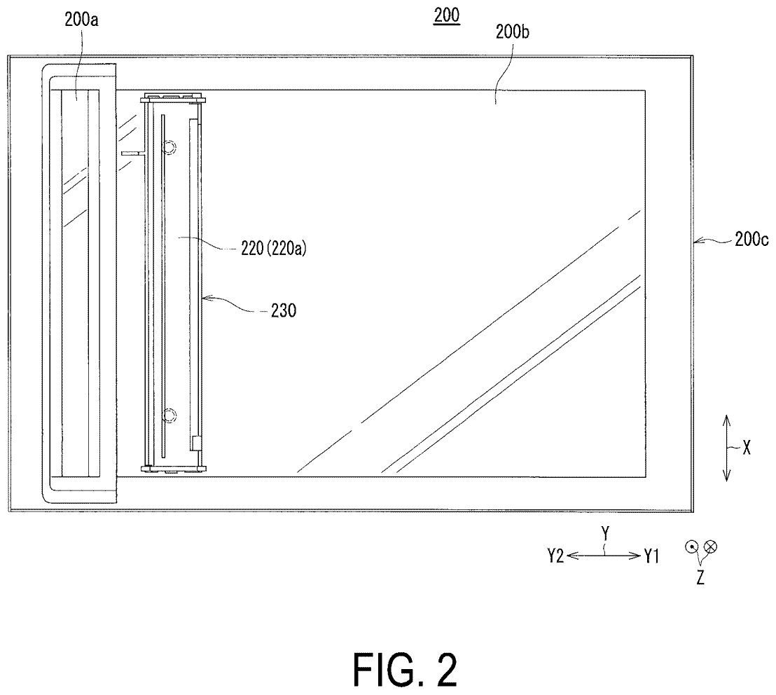

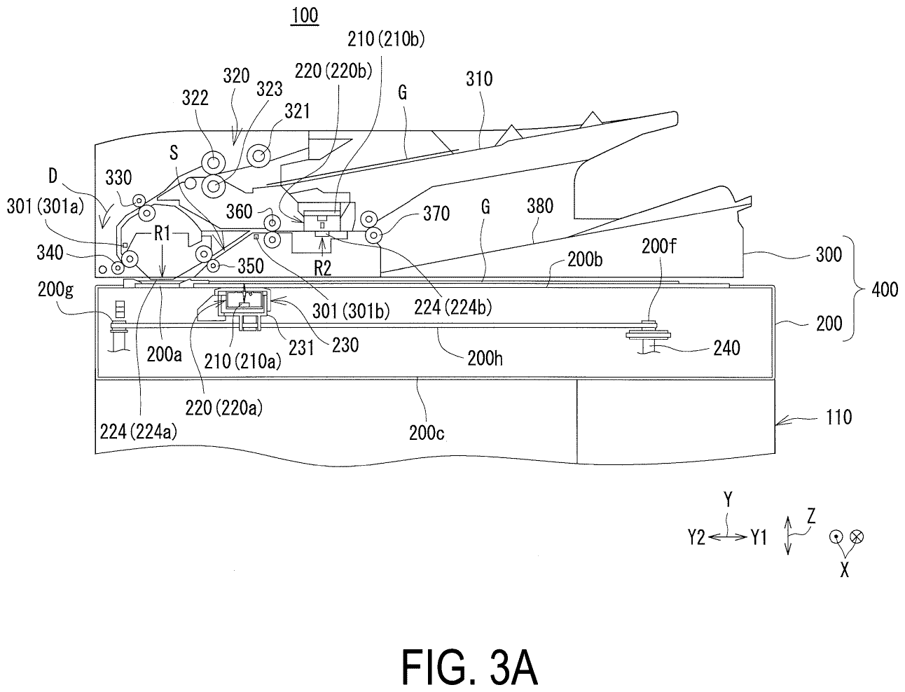

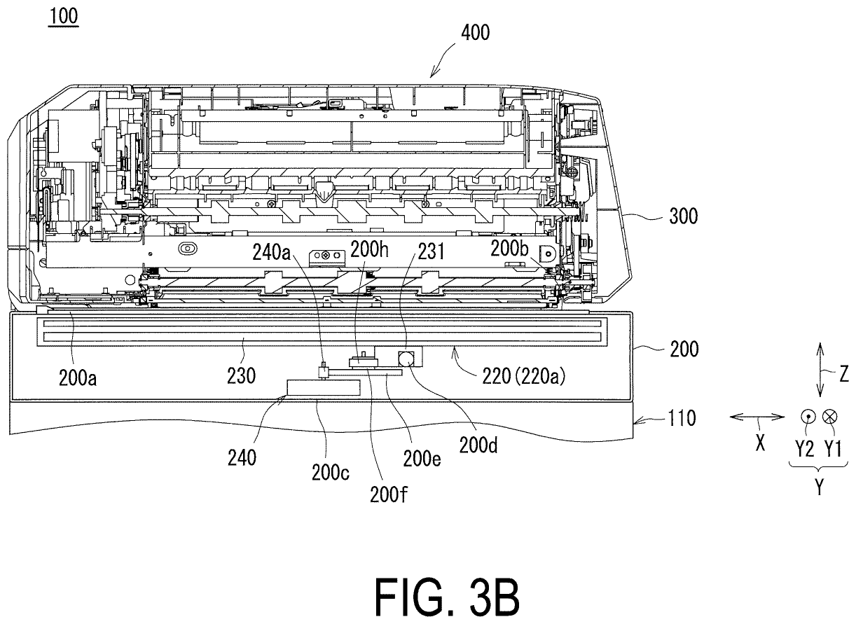

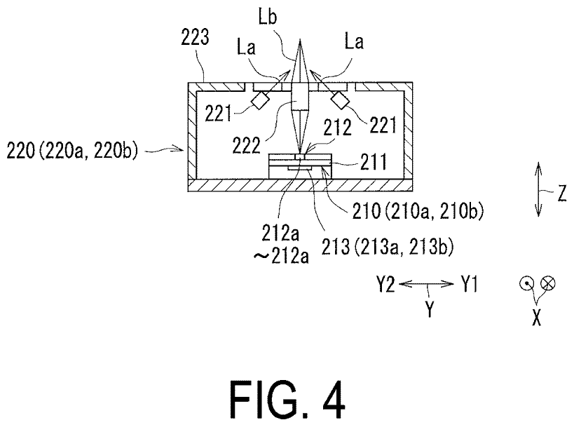

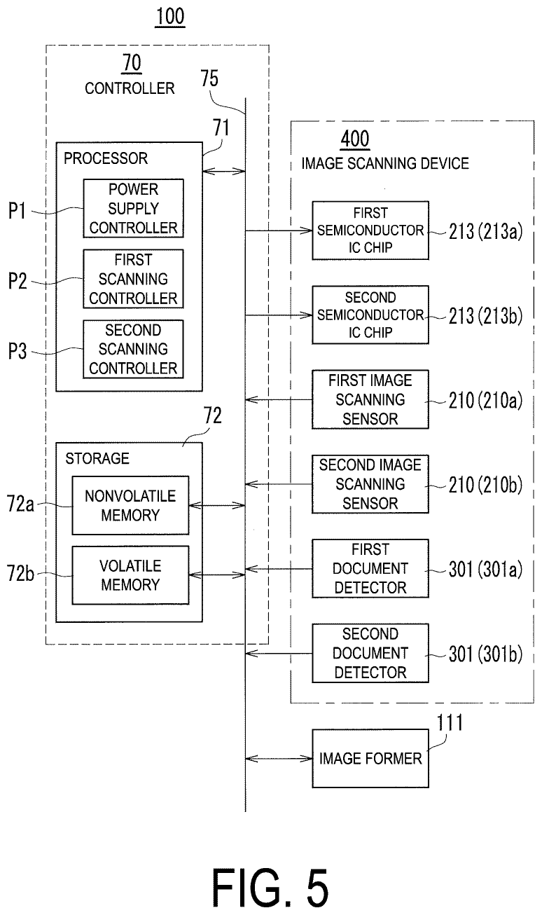

FIG. 1 is a cross-sectional view illustrating an image forming device 100 including an image scanning device 400 according to the present embodiment. FIG. 2 is a plan view of an image scanner 200 illustrated in FIG. 1 viewed from above. FIGS. 3A and 3B are cross-sectional views of the image scanning device 400 part in the image forming device 100 viewed from the front side and the side surface side, respectively. FIG. 4 is a schematic cross-sectional view of the image scanning sensors 210 (210a and 210b) in the image scanning device 400. Note that, in FIG. 4, the first image scanning sensor 210 (210a) and the second image scanning sensor 210 (210b) have substantially the same configuration, and thus they are denoted by the same symbols and are illustrated in one drawing. FIG. 5 is a system block diagram illustrating an example of a schematic configuration of the image forming device 100.

The image forming device 100 includes the image scanning device 400 and an image forming device body 110.

The image scanning device 400 is provided at an upper portion of the image forming device body 110, and includes the image scanner 200 and a document conveyor 300 (automatic document feeding device). The image scanner 200 includes a document scanning member 200a (to be specific, a document scanning glass) that defines a first image scanning position R1 (an example of the image scanning position) (see FIG. 3A) for the front surface of the conveyed document G, and a document table 200b (to be specific, a document glass) on which the document G is placed. The image scanner 200 scans the document G placed on the document table 200b, or scans the front surface of the document G conveyed by the document conveyor 300 at the first image scanning position R1 of the document scanning member 200a. When further scanning the back surface of the document G, the image scanner 200 scans the back surface of the document G conveyed by the document conveyor 300 at a second image scanning position R2 for the back surface (another example of the image scanning position) (see FIG. 3A) on the downstream side from the first image scanning position R1 in a conveying direction D.

The document table 200b is provided above the image scanner 200. The document conveyor 300 automatically conveys the document G toward the first image scanning position R1 and the second image scanning position R2. In addition, the document conveyor 300 is provided so as to be openable and closable around an axis along a sub-scanning direction Y on a rear surface side that is the first side in the main scanning direction X with respect to the image scanner 200. Here, the main scanning direction X is a direction orthogonal to the conveying direction D of the document G, and the sub-scanning direction Y is a direction parallel to the convey direction of the document G. The rear surface side (second side Y2 in the sub-scanning direction Y) is an opposite side to an operation side (first side Y1 in the sub-scanning direction Y). Reference sign Z indicates an up-down direction.

The document conveyor 300 is rotatably supported by a hinge with respect to the image scanner 200. The document conveyor 300 opens the document table 200b and also serves as an example of a document presser pressing the document G placed on the document table 200b from above.

The image forming device 100 includes an image former 111 (see FIG. 1) that forms a multicolor image or a monochrome image on a sheet P (recording sheet such as recording paper) in accordance with an image of the document G scanned by the image scanning device 400 or image data received from the outside.

The image former 111 includes an optical scanning device 11, a development device 12, a photoreceptor drum 13, a drum cleaning device 14, a charger 15, an intermediate transfer belt device 20, a fixing device 17, and a secondary transfer device 26. The image data used in the image forming device 100 corresponds to a color image using a plurality of (four in this example) colors such as black (K), cyan (C), magenta (M), and yellow (Y). Accordingly, in this example, four development devices 12, four photoreceptor drums 13, four drum cleaning device 14, and four chargers 15, are provided and set to black, cyan, magenta, and yellow to form four latent images, respectively, corresponding to each color. Four image stations Pa, Pb, Pc, and Pd are configured. The image forming device 100 further includes a feed tray 18 and a discharge tray 39.

In the image forming device 100, the sheet P supplied by the feed tray 18 is conveyed to sheet registration rollers 34 by conveying rollers 35 along a sheet conveyance path Ra. Next, the sheet P is conveyed to a transfer roller 26a by the sheet registration rollers 34 at a timing at which the sheet P and a toner image on an intermediate transfer belt 21 circulating in a circumferential direction C are aligned with each other. The toner on the intermediate transfer belt 21 is transferred onto the sheet P by the transfer roller 26a. Thereafter, the sheet P passes through a fixing roller 31 and a pressure roller 32 in the fixing device 17, and is discharged onto the discharge tray 39 via sheet discharge rollers 36. When image formation is performed not only on the front surface but also on the back surface of the sheet P, the sheet P is conveyed in the reverse direction from the sheet discharge rollers 36 to a reverse sheet conveyance path Rb. The sheet P is reversed via reverse conveying rollers 35a and is guided again to the sheet registration rollers 34. After the toner image is formed and fixed on the back surface of the sheet P in the same manner as the front surface, the sheet P is discharged toward the discharge tray 39.

### Image Scanning Device

The image scanning device 400 includes the image scanning units 220 (220a and 220b).

### -Image Scanner-

The image scanner 200 includes a document scanning member 200a having a transparent plate shape, the document table 200b having a transparent plate shape, a housing 200c, a scanning unit 230 (scanning body), and a driver 240 (scanner motor) (see FIGS. 3A and 3B).

The scanning unit 230 is provided with the first image scanning unit 220 (220a). The first image scanning unit 220 (220a) includes the first image scanning sensor 210 (210a) (in this example, a contact image sensor) that scans the document G. The scanning unit 230 is provided below the document scanning member 200a and the document table 200b to be capable of reciprocating along the sub-scanning direction Y with respect to the housing 200c, and is driven by the driver 240.

Specifically, the housing 200c is provided with a guide shaft 200d (see FIG. 3B) along the sub-scanning direction Y. In the scanning unit 230, a support guide 231 is slidably provided to the guide shaft 200d. The driver 240 is provided on the first side Y1 in the sub-scanning direction Y of the housing 200c. As illustrated in FIG. 3B, a driving gear 240a of the driver 240 is engaged with a belt gear 200e, and the belt gear 200e is provided with a drive pulley 200f. A driven pulley 200g is provided on the second side Y2 in the sub-scanning direction Y of the housing 200c. A scanning belt 200h is wound around the drive pulley 200f and the driven pulley 200g. The scanning belt 200h is fixed to the support guide 231 of the scanning unit 230. As a result, the driving gear 240a of the driver 240 rotates in a first direction and a second direction, so that the scanning unit 230 can be reciprocated along the sub-scanning direction Y.

The image scanning device 400 is configured to perform a document moving scanning operation and a document fixed scanning operation under an instruction from a controller 70.

In the document moving scanning operation, the image scanning device 400 stops the scanning unit 230 at the first image scanning position R1 below the document scanning member 200a by the driver 240, and scans the front surface of the document G conveyed by the document conveyor 300 and passing over the document scanning member 200a. by the first image scanning sensor 210 (210a) in the first image scanning unit 220 (220a). When scanning the back surface of the document G in the document moving scanning operation, the image scanning device 400 scans the back surface of the document G conveyed by the document conveyor 300 and passing through the second image scanning unit 220 (220b) by the second image scanning sensor 210 (210b) in the second image scanning unit 220 (220b).

In addition, in the fixed document scanning operation, the image scanning device 400 scans the document G placed on the document table 200b by the first image scanning sensor 210 (210a) in the first image scanning unit 220 (220a) while moving the scanning unit 230 to the first side Y1 in the sub-scanning direction Y along the document table 200b.

### -Document Conveyor-

In the image scanning device 400, the document G is conveyed toward the image scanning positions (R1 and R2) scanned by the image scanning sensors 210 (210a and 210b), and the document G conveyed to the image scanning positions (R1 and R2) is conveyed to the downstream side from the image scanning positions (R1 and R2) in the conveying direction D of the document G while being scanned by the image scanning sensors 210 (210a and 210b).

The document conveyor 300 includes a document placement tray 310, a supply roller 320, a document conveyance path S, a first conveying roller 330, a document registration roller 340, a second conveying roller 350, third conveying rollers 360, document discharge rollers 370, and a document discharge tray 380.

The document placement tray 310 is for placing one or a plurality of the documents G, and is disposed above the document conveyor 300. The supply roller 320 pulls out the documents G placed on the document placement tray 310 one by one. The supply roller 320 includes a take-in roller 321 (pickup roller), a supply roller 322, and a separation member 323 (in this example, a separation roller) such as a separation roller or a separation pad. The take-in roller 321 feeds the document G placed on the document placement tray 310 from the document placement tray 310 into the document conveyance path S along the conveying direction D of the document G. The feed roller 322 further conveys the document G fed by the take-in roller 321 to the downstream side in the conveying direction D while nipping the document G along with the separation member 323. The separation member 323 is in a state of facing the feed roller 322 and separates the documents G so that the document G conveyed between the separation member 323 and the feed roller 322 becomes one sheet.

The document conveyance path S guides the document G pulled out by the supply roller 320 to the discharge side (below the document placement tray 310) via the document scanning member 200a. The first conveying roller 330, the document registration roller 340, the second conveying roller 350, the third conveying rollers 360, and the document discharge rollers 370 are provided on the document conveyance path S. The first conveying roller 330 conveys the document G pulled out by the supply roller 320 to the document registration roller 340. The document registration roller 340 conveys the document G conveyed by the first conveying roller 330 onto the document scanning member 200a. The second conveying roller 350 conveys the document G conveyed from the document scanning member 200a toward the third conveying rollers 360. The third conveying rollers 360 cause the document G conveyed by the second conveying roller 350 to pass through the second image scanning sensor 210 (210b) and convey the document G toward the document discharge rollers 370. The document discharge rollers 370 discharge the document G conveyed from the third conveying rollers 360 toward the document discharge tray 380. The document discharge tray 380 is disposed below the document placement tray 310, and places the document G discharged by the document discharge roller 370.

As illustrated in FIG. 3A and 5, the document conveyor 300 further includes a first document detector 301 (301a) (an example of a document detector) and a second document detector 301 (301b) (another example of the document detector).

The first document detector 301 (301a) (in this example, an actuator type photosensor) is provided on the upstream side from the first image scanning position R1 in the conveying direction D in the document conveyance path S (in this example, near the upstream side of the document registration roller 340). The second document detector 301 (301b) (in this example, an actuator type photosensor) is provided on the upstream side from the second image scanning position R2 in the conveying direction D in the document conveyance path S (in this example, near the upstream side of the third conveying rollers 360).

As illustrated in FIG. 4, the image scanning units 220 (220a and 220b) each includes one or a plurality of (two in this example) the light sources 221 and 221, a condenser lens array 222, the image scanning sensors 210 (210a and 210b), and a housing 223. The light sources 221 and 221, the condenser lens array 222, and the image scanning sensor 210 are provided in the housing 223. The image scanning units 220 (220a and 220b) each irradiates the document G with the emission light La and La emitted from the light sources 221 and 221, respectively, and scans a reflected light Lb reflected from the document G by the scanning element unit 212 in the image scanning sensor 210 via the condenser lens array 222.

The light sources 221 and 221 irradiate the document G with the emission light La and La, respectively. The condenser lens array 222 condenses the reflected light Lb (image light) reflected from the document G on the scanning element unit 212 in the image scanning sensor 210. The image scanning sensors 210 (210a and 210b) each photoelectrically converts the reflected light Lb received by the scanning element unit 212 through the condenser lens array 222 and outputs image data. The scanning element unit 212 includes a plurality of (to be specific, 5184) scanning elements 212a to 212a arranged side by side on the substrate 211 along the main scanning direction X, and is a line image sensor in this example. The substrate 211 of the image scanning sensors 210 (210a and 210b) is provided with the plurality of scanning elements 212a to 212a and the electronic components (in this example, the semiconductor IC chips 213). Examples of the semiconductor IC chip 213 include a chip that converts an analog signal into a digital signal and a chip that amplifies an analog signal, and typically an analog front-end IC chip (AFE) (in this example, 10 mm×10 mm chip) that adjusts (for example, converts an analog signal into a digital signal) an analog signal output from the plurality of scanning elements 212a to 212a.

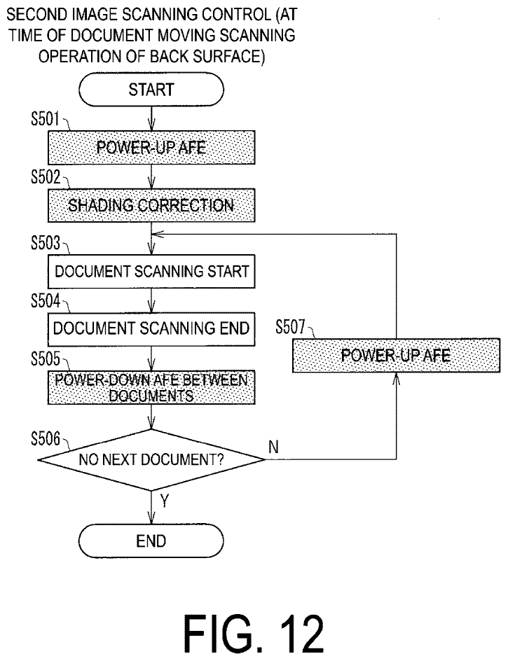

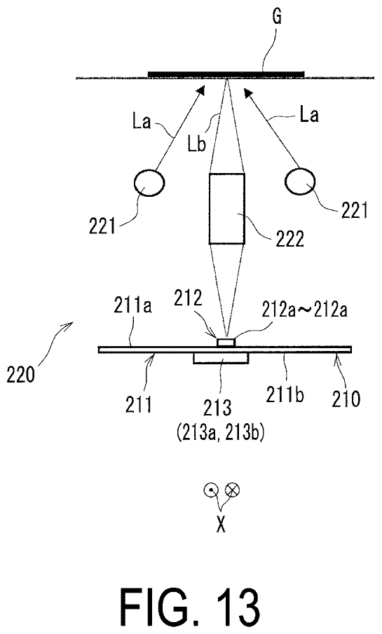

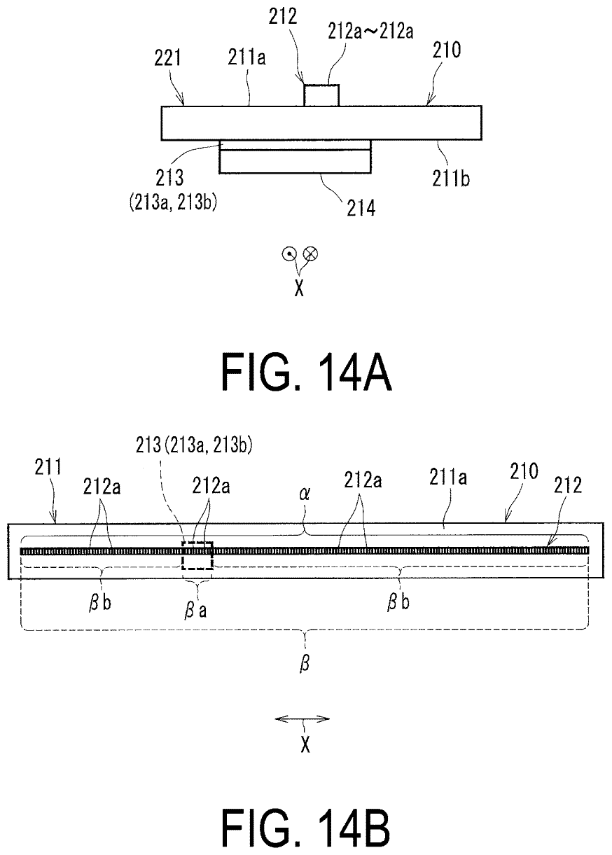

The image scanning units 220 (220a and 220b) each has the same configuration as a known configuration illustrated in FIGS. 13 to 14B described above.

That is, as illustrated in FIGS. 13 to 14B, the image scanning sensors 210 (210a and 210b) each has the scanning element region α (see FIG. 14B) that is the region in which the plurality of scanning elements 212a to 212a are arranged side by side in the main scanning direction X on the scanning element placement side surface 211a of the substrate 211 on which the plurality of scanning elements 212a to 212a are disposed. In this example, the electronic component provided on the substrate 211 is the semiconductor IC chip 213 (in this example, the analog front-end IC chip (AFE)). The semiconductor IC chip 213 includes a first semiconductor IC chip 213a and a second semiconductor IC chip 213b. For example, the semiconductor IC chips 213 (213a and 213b) may be provided on the scanning element corresponding region β (see FIG. 14B) corresponding to the scanning element region α on an opposite surface 211b opposite to the scanning element placement side surface 211a of the substrate 211 in the image scanning sensors 210 (210a and 210b) or at the predetermined electronic component placement location βa (see FIG. 14B) near the scanning element corresponding region β. In this example, the semiconductor IC chips 213 (213a and 213b) are provided at the electronic component placement location βa on the scanning element corresponding region β, and the semiconductor IC chips 213 (213a and 213b) each is provided with the heat dissipation member 214 (heat dissipation pad) (see FIG. 14A).

The image scanning sensors 210 (210a and 210b) each converts the reflected light Lb from the document G into an electric signal as image data.

In this example, the image scanning sensors 210 (210a and 210b) each is referred to as a contact image sensor (CIS), and has a shape elongated in the main scanning direction X. More specifically, the light sources 221 and 221 irradiate the front surface of the document G at the first image scanning sensor 210 (210a) and irradiate the back surface of the document G at the second image scanning sensor 210 (210b), respectively, with the emission light La and La. The light sources 221 and 221 are light emitting diode elements (LED). The condenser lens array 222 forms an image of the reflected light Lb reflected from the document G at the same magnification. The condenser lens array 222 is an erecting equal-magnification lens. The plurality of scanning elements 212a to 212a receive the reflected light Lb that has passed through the condenser lens array 222.

As illustrated in FIG. 5, the image forming device 100 includes the controller 70. The controller 70 may be provided in the image scanning device 400. The controller 70 includes a processor 71 including a microcomputer such as a CPU, and a storage 72 including a nonvolatile memory 72a such as a ROM and a volatile memory 72b such as a RAM. The processor 71 loads a control program stored in advance in the nonvolatile memory 72a of the storage 72 onto the volatile memory 72b of the storage 72 and executes the control program, so that the controller 70 performs operation control of various components.

The controller 70 is connected to the storage 72 via an internal bus 75. The image scanning device 400 and the image former 111 are connected to the controller 70 via the internal bus 75.

The controller 70 controls the entire image forming device 100. The nonvolatile memory 72a stores a start-up program of the image forming device 100 and default values for various kinds of information. The volatile memory 72b is used as a working area and a buffer area of the controller 70.

The semiconductor IC chips 213 (213a and 213b) (AFE) are electrically connected to an output system of the controller 70. As a result, the controller 70 can supply power to the semiconductor IC chips 213 (213a and 213b).

The image scanning sensors 210 (210a and 210b) are electrically connected to an input system of the controller 70. As a result, the controller 70 can receive the image signal from the image scanning sensors 210 (210a and 210b).

The document detectors 301 (301a and 301b) are electrically connected to the input system of the controller 70. As a result, the controller 70 can supply power to the semiconductor IC chips 213 (213a and 213b) before reaching the image scanning positions (R1 and R2) by detecting a leading edge of the document G by the document detectors 301 (301a and 301b), that is, at a timing when scanning can be performed by the scanning element unit 212 when the semiconductor IC chips 213 (213a and 213b) (AFE) is activated by power supply to the semiconductor IC chips 213 (213a and 213b).

### First Embodiment

In FIG. 6, upper diagram is a timing chart showing a supply timing at which power is supplied to the semiconductor IC chips 213 (213a and 213b) (AFE) in scanning control of a first document G, and a lower diagram is a timing chart showing a supply timing at which power is supplied to the semiconductor IC chips 213 (213a and 213b) (AFE) in scanning control of a second and subsequent documents G.

Here, the first document G is a document that is placed on the document placement tray 310 and is first conveyed from the document placement tray 310 toward the scanning position by an execution key provided on an operation panel (not illustrated). The second and subsequent documents G are documents to be conveyed next after the first document is conveyed.

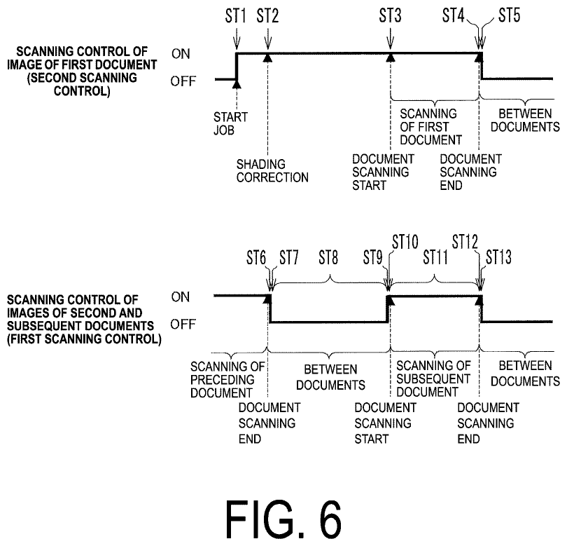

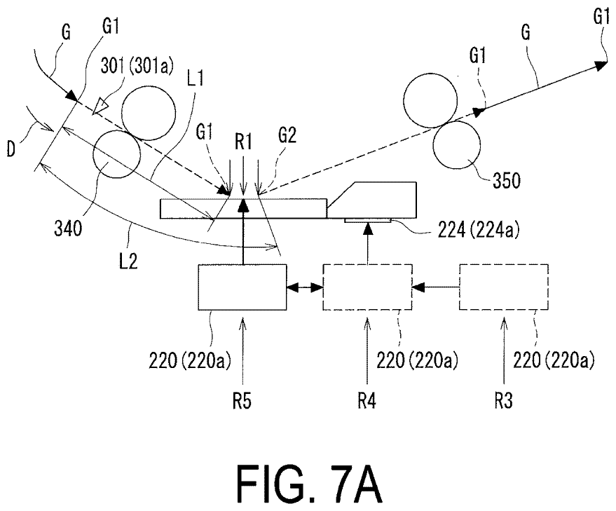

FIGS. 7A and 7B are front views schematically illustrating scanning states of the document G by the first image scanning unit 220 (220a) and the second image scanning unit 220 (220b), respectively.

The controller 70 includes a power supply controller P1 and a first scanning controller P2. The power supply controller P1 controls power supply to the electronic components (semiconductor IC chips 213 (213a and 213b)) in the image scanning sensors 210 (210a and 210b), respectively. When scanning the document G, the first scanning controller P2 conveys the document G toward the image scanning positions (R1 and R2) in a power supply stop state in which power supply to the electronic components (213 (213a and 213b)) is stopped by the power supply controller P1. The first scanning controller P2 sets a power supply state in which power is supplied to the electronic components (213 (213a and 213b)) by the power supply controller P1 before scanning the document G at the image scanning positions (R1 and R2), scans the document G at the image scanning positions (R1 and R2) in the power supply state, and sets the power supply stop state after scanning the document G at the image scanning positions (R1 and R2). In the following description, the power supply state may be referred to as a power-up state, and the power supply stop state may be referred to as a power-down state.

In this example, when continuously scanning a plurality of the documents G to G and scanning the second and subsequent documents G to G, after the scanning of a preceding document G at the image scanning positions (R1 and R2) is ended (ST6: see the lower drawing in FIG. 6), the first scanning controller P2 suppresses the power to be lower than a reference power to be supplied to the electronic components (213 (213a and 213b)) or sets the power-down state (power supply stop state) in which the power supplied to the electronic components (213 (213a and 213b)) is turned off (ST7: see the lower drawing in FIG. 6) by the power supply controller P1. Next, the first scanning controller P2 conveys the document G toward the image scanning positions (R1 and R2) in the power-down state (ST8: see the lower drawing in FIG. 6). Here, the reference power is a voltage at which the electronic components (213 (213a and 213b)) can operate normally.

Next, the first scanning controller P2 sets the power-up state (power supply state) in which the reference power is supplied to the electronic components (213 (213a and 213b)) by the power supply controller P1 before scanning the subsequent document G at the image scanning positions (R1 and R2), (ST9: see the lower drawing in FIG. 6), and starts scanning the document G at the image scanning positions (R1 and R2) at a predetermined scanning start timing (ST10: see the lower drawing in FIG. 6).

Specifically, as illustrated in FIGS. 7A and 7B, when scanning the front surface of the document G, the first scanning controller P2 detects a leading edge G1 of the document G by the first document detector 301 (301a), and then sets the power-up state by the power supply controller P1 before the first image scanning position R1 after a predetermined first time period calculated from a predetermined first upstream conveying distance L1 (see FIG. 7A) recognized in advance and a conveyance speed of the document G has elapsed. Thereafter, the first scanning controller P2 starts scanning of the front surface of the document G by the first image scanning sensor 210 (210a) at the first image scanning position R1 at the predetermined scanning start timing. When scanning the back surface of the document G, the second scanning controller P3 detects the leading edge G1 of the document G by the second document detector 301 (301b), and then sets the power-up state by the power supply controller P1 before the second image scanning position R2 after a predetermined third time period calculated from a predetermined second upstream conveying distance L3 (see FIG. 7B) recognized in advance and the conveyance speed of the document G has elapsed. Thereafter, the second scanning controller P3 starts scanning of the back surface of the document G by the second image scanning sensor 210 (210b) at the second image scanning position R2 at the predetermined scanning start timing.

Next, the first scanning controller P2 and the second scanning controller P3 convey the document G while scanning the document G at the image scanning positions (R1 and R2), respectively, in the power-up state (ST11: see the lower drawing in FIG. 6), and after scanning of the front surface and the back surface of the document G at the image scanning positions (R1 and R2), respectively, is completed at a predetermined scanning end timing (ST12: see the lower drawing in FIG. 6), the power-down state is set by the power supply controller P1 (ST13: see the lower drawing in FIG. 6).

Next, as illustrated in FIGS. 7A and 7B, when scanning the front surface of the document G, the first scanning controller P2 detects a trailing edge G2 of the document G by the first document detector 301 (301a), and then sets the power-down state by the power supply controller P1 after the predetermined scanning end timing and after detecting that the trailing edge G2 of the document G has passed the first image scanning position R1 after a predetermined second time period calculated from a predetermined first downstream side conveying distance L2 (see FIG. 7A) recognized in advance and the conveyance speed of the document G has elapsed. When scanning the back surface of the document G, the second scanning controller P3 detects the trailing edge G2 of the document G by the second document detector 301 (301b), and then sets the power-down state by the power supply controller P1 after the predetermined scanning end timing and after detecting that the trailing edge G2 of the document G has passed the second image scanning position R2 after a predetermined fourth time period calculated from a predetermined second downstream side conveying distance L4 (see FIG. 7B) recognized in advance and the conveyance speed of the document G has elapsed.

Occurrence of the density unevenness in a formed image between the image near the electronic component placement location βa and the image in the location away from the electronic component placement location βa can be suppressed by executing the shading correction for each scanning of the document G. However, the shading correction cannot be performed within the limited period of time between the preceding document G and the succeeding document G. This is particularly remarkable when the shading correction accompanying movement (which requires time for movement) of the first image scanning sensor 210 (210a) between the shading position R4 (see FIG. 7A) and the first image scanning position R1 (see FIG. 7A) is performed.

In this regard, according to the present embodiment, when scanning the second and subsequent documents G, the document G is conveyed toward the image scanning positions (R1 and R2) in the power-down state (power supply stop state) without executing the shading correction for each scanning of the document G, the power-up state (power supply state) is set before scanning the document G at the image scanning positions (R1 and R2), the document G is scanned at the image scanning positions (R1 and R2) in the power-up state (power supply state), and the power-down state (power supply stop state) is set after scanning the document G at the image scanning positions (R1 and R2).

As described above, the power-down state (power supply stop state) can be set on the electronic components (213 (213a and 213b)) between the preceding document G and the succeeding document G which are continuously scanned without executing the shading correction for each scanning of the document G. Thus, even when the plurality of documents G to G are continuously scanned, an increase in the temperature of the electronic components (213 (213a and 213b)) on the substrate 211 can be suppressed. As a result, the temperature of the scanning elements 212a to 212a near the electronic component placement location βa can be suppressed to be higher than that of the scanning elements 212a to 212a and 212a to 212a in the other regions βb and βb, respectively. Consequently, occurrence of density unevenness in a formed image between the image near the electronic component placement location βa and the image in the location away from the electronic component placement location βa can be suppressed.

This is particularly effective when the image scanning sensors 210 (210a and 210b) are contact image sensors and the electronic components are the semiconductor IC chips 213 (213a and 213b) (analog front-end IC chips in this example) provided on the scanning element corresponding region β on the opposite surface 211b of the substrate 211 in the image scanning sensors 210 (210a and 210b) or at the predetermined electronic component placement location βa near the scanning element corresponding region β.

### Second Embodiment

In some cases, it is preferable to execute the shading correction when a job is requested. For example, in a case where the plurality of documents G to G are continuously scanned in a previous job, a next job may be executed while the temperature of the electronic components (213 (213a and 213b)) increases and the temperature of the electronic components (213 (213a and 213b)) does not completely decrease.

In this regard, in the present embodiment, the controller 70 further includes the second scanning controller P3.

When scanning the first document G (i.e., for each job request), the second scanning controller P3 sets the power-up state (power supply state) by the power supply controller P1 (ST1: see the upper drawing in FIG. 6), and executes the shading correction in the power-up state (power supply state) (ST2: see the upper drawing in FIG. 6).

The controller 70 scans the first document G at the image scanning positions (R1 and R2) remaining the power-up state (power supply state) (ST3: see the upper drawing in FIG. 6) after executing the shading correction. After scanning the first document G at the image scanning positions (R1 and R2) (ST4: see the upper drawing in FIG. 6), the controller 70 sets the power-down state (power supply stop state) by the power supply controller P1 (ST5: see the upper drawing in FIG. 6).

In this way, the shading correction can be executed for each job request, and thus, occurrence of density unevenness can be suppressed for each job request. For example, when a plurality of documents G to G are continuously scanned in the previous job, even when the next job is executed while the temperature of the electronic components (213 (213a and 213b)) increases, and the temperature of the electronic components (213 (213a and 213b)) does not completely decrease, the shading correction is performed on the first document G. Thus occurrence of density unevenness in a formed image between the image near the electronic component placement location βa and the image in the location away from the electronic component placement location βa can be suppressed.

Here, the shading correction is correction for correcting unevenness in the amount of light to the plurality of scanning elements 210a to 210a in the image scanning sensors 210 (210a and 210b), and can perform correction by, for example, the following equation.

A gradation value Pout(i) after the shading correction of output values of the image scanning sensors 210 (210a and 210b) when the light sources 221 and 221 are turned on and the reflected light Lb reflected from the document G is received can be calculated by the following equation:

Pout(i)={[P(i)−K(i)]/[W(i)−K(i)]}×γ

where K(i) (i is an integer of 1 to n, n is the number of the scanning elements 212a to 212a, n=5184 in this example) is the output value of the image scanning sensors 210 (210a and 210b) when the light sources 221 and 221 are turned off, W(i) is the output value of the image scanning sensors 210 (210a and 210b) when the light sources 221 and 221 are turned on and the reflected light Lb reflected from a reference white plates 224 (224a and 224b) (shading plates) (see FIGS. 3A, 7A, 7B) is received, P(i) is the output value of the image scanning sensors 210 (210a and 210b) when the light sources 221 and 221 are turned on and the reflected light Lb reflected from the document G is received, and γ (200 in this example) is a coefficient of the gradation value corresponding to the output value of the image scanning sensors 210 (210a and 210b). In this example, Pout(i)=0 to 255.

### Third Embodiment

In the present embodiment, the controller 70 performs a conveying process of conveying the first document G to the image scanning positions (R1 and R2) and a correction process of executing the shading correction in parallel.

In this way, while the first document G is conveyed to the image scanning positions (R1 and R2), the shading correction, in particular, the shading correction accompanying movement of the first image scanning sensor 210 (210a) can be performed, and accordingly, shortening of image scanning time of the first document G can be realized.

### Fourth Embodiment

In the present embodiment, the controller 70 sets the power-up state (power supply state) when starting up the image scanning device 400 (image forming device 100), executes the shading correction in the power-up state (power supply state), and sets the power-down state (power supply stop state) after executing the shading correction.

In this way, the shading correction can be executed for each start-up of the image scanning device 400 (image forming device 100), and thus, the occurrence of the density unevenness can be suppressed for each start-up time.

### Fifth Embodiment

In the present embodiment, the controller 70 sets the power-up state (power supply state) or the power-down state (power supply stop state) based on timing detection before scanning the document G at the image scanning positions (R1 and R2) and timing detection after scanning the document G at the image scanning positions (R1 and R2), which are detected using the document detectors 301 (301a and 301b) provided in the document conveyance path S.

In this way, the power-up state (power supply state) or the power-down state (power supply stop state) can be easily set using the existing document detectors 301 (301a and 301b) provided in the document conveyance path S of the document G.

### Image Scanning Mode by First Image Scanning Sensor 210 (210a)

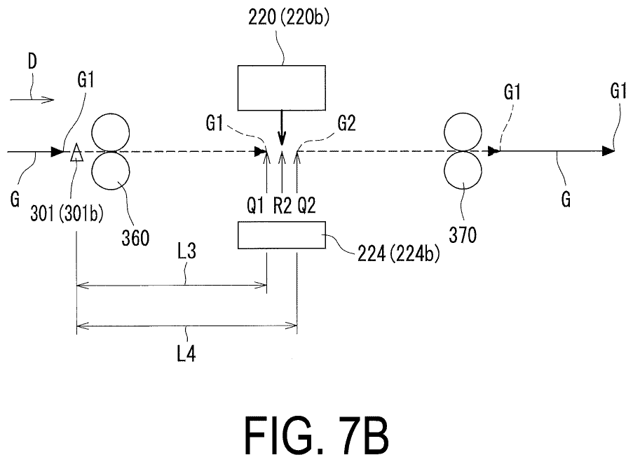

FIGS. 8 to 10 are flowcharts of examples of scanning control performed by the first image scanning sensor 210 (210a) at the start-up time of the first image scanning control, at the time of the document fixed scanning operation, and at the time of the document moving scanning operation of the front surface, respectively.

### -Start-Up Time-

As shown in FIG. 8, at the start-up time, the controller 70 sets the power-up state on the AFE (semiconductor IC chip 213 (213a)) (S101), and moves the first image scanning unit 220 (220a) from a standby position R3 (see FIG. 7A) to a position below the shading position R4 (see FIG. 7A) of the reference white plate 224 (224a) (S102). Next, the controller 70 adjusts a gain for an amplifier in the AFE (213) (S103) and performs the shading correction (S104). Next, the controller 70 moves the first image scanning unit 220 (220a) to the standby position R3 (S105) and sets the power-down state on the AFE (213) (S106). Here, the gain adjustment for the amplifier is an operation of adjusting the gain of the amplifier to such an extent that an output level of the AFE does not deviate from an allowable range.

### -At Time of Document Fixed Scanning Operation-

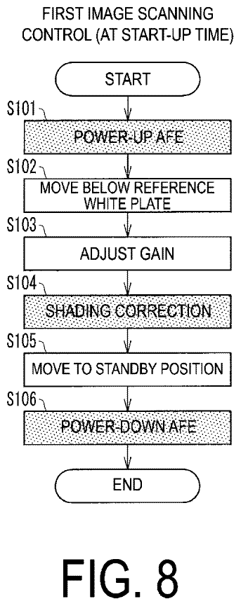

As shown in FIG. 9, at the time of the document fixed scanning operation, when receiving a turn on operation of a print key, the controller 70 sets the power-up state (S201) on the AFE 213 (semiconductor IC chip 213 (213a)), returns the first image scanning unit 220 (220a) from the standby position R3 (see FIG. 7A) (S202), performs the shading correction at the shading position R4 (see FIG. 7A) (S203), moves the first image scanning unit 220 (220a) to a start position R5 (see FIG. 7A) (S204), feeds the first image scanning unit 220 (220a) (S205), and scans the document G while moving the first image scanning unit 220 to the first side Y1 in the sub-scanning direction Y (S206 and S207). Next, the controller 70 moves the first image scanning unit 220 (220a) to the standby position R3 (see FIG. 7A) (S208) and sets the power-down state on the AFE (213) (S209).

### -At Time of Document Moving Scanning Operation of Front Surface-

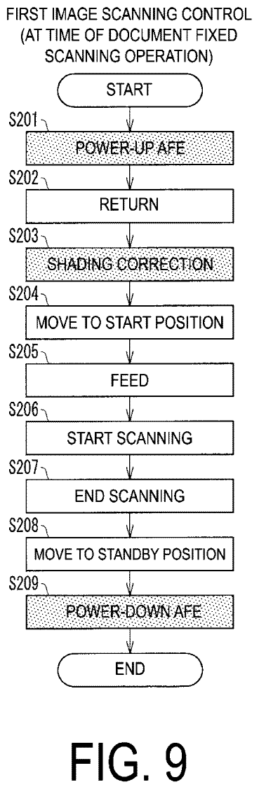

As shown in FIG. 10, at the time of the document moving scanning operation of the front surface, when receiving the turn on operation of the print key, the controller 70 sets the power-up state on the AFE 213 (semiconductor IC chip 213 (213a)) (S301), returns the first image scanning unit 220 (220a) from the standby position R3 (see FIG. 7A)) (S302), and performs the shading correction at the shading position R4 (see FIG. 7A)) (S303). Next, the controller 70 moves the first image scanning unit 220 (220a) to the first image scanning position R1 (see FIG. 7A) (S304), and scans the front surface of the document G by the first image scanning sensor 210 (210a) while conveying the document G (S305 and S306). Next, the controller 70 sets the power-down state on the AFE (213) (S307), and determines whether there is a next document G (S308). Next, if the controller 70 determines that the next document G is present (S308: N), then the controller 70 sets the power-up state on the AFE (213) (S309) and proceeds to 5305, and if the controller 70 determines that the next document G is not present (S308: Y), then the controller 70 moves the first image scanning unit 220 (220a) to the standby position R3 (see FIG. 7A) (S310).

### Image Scanning Mode by Second Image Scanning Sensor 210 (210b)

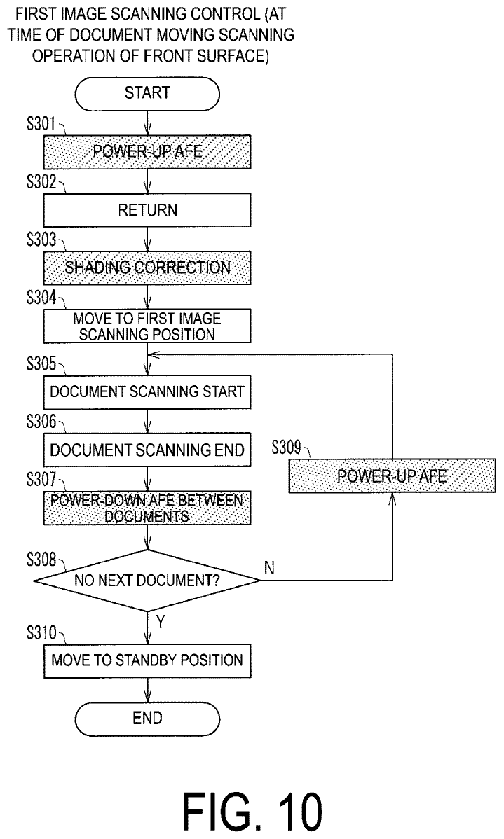

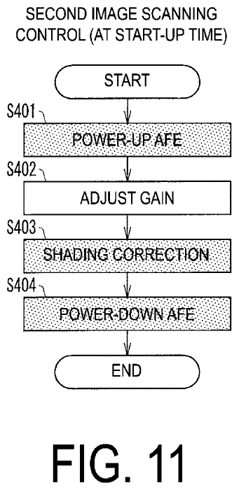

FIGS. 11 and 12 are flowcharts of examples of scanning control at the start-up time in the second image scanning control and at the time of the document moving scanning operation of the back surface, by the second image scanning sensor 210 (210b).

### -Start-Up Time-

As shown in FIG. 11, at the start-up time, the controller 70 sets the power-up state on the AFE (semiconductor IC chip 213 (213b)) (S401), adjusts the gain for the amplifier in the AFE (213) (S402), performs the shading correction (S403), and sets the power-down state on the AFE (213) (S404).

### -At Time of Document Moving Scanning Operation of Back Surface-

As shown in FIG. 12, at the time of the document moving scanning operation of the back surface, when receiving the turn on operation of the print key, the controller 70 sets the power-up state on the AFE (semiconductor IC chip 213 (213b)) (S501), performs the shading correction (S502), and scans the back surface of the document G by the second image scanning sensor 210 (210b) while conveying the document G (S503 and S504). Next, the controller 70 sets the power-down state on the AFE (213) (S505), and determines whether there is a next document G (S506). Next, if the controller 70 determines that the next document G is present (S506: N), then the controller 70 sets the power-up state on the AFE (213) (S507) and proceeds to 5503, and if the controller 70 determines that the next document G is not present (S506: Y), then the controller 70 ends the process.

Here, in the case of the image scanning mode by the second image scanning sensor 210 (210b), it is difficult to clean the reference white plate 224 (224b), and thus the shading correction may be omitted. This is particularly effective in the color image scanning mode. In this case, when the shading correction is performed in the production process, there is no particular problem even when the shading correction is omitted.

The disclosure is not limited to the embodiments described above and can be implemented in various other forms. Thus, the above embodiments are merely examples in all respects and should not be interpreted as limiting. The scope of the disclosure is indicated by the claims and is not limited to the description. Furthermore, all modifications and changes equivalent in scope with the claims are included in the scope of the disclosure.

### REFERENCE SIGNS LIST

100 Image forming device
200 Image scanner
210 Image scanning sensor
210a First image scanning sensor (example of image scanning sensor)
210b Second image scanning sensor (another example of image scanning sensor)
211 Substrate
211a Scanning element placement side surface
211b Opposite surface
212 Scanning element unit
212a Scanning element
213 Semiconductor IC chip (example of electronic component: AFE)
213a First semiconductor IC chip
213b Second semiconductor IC chip
214 Heat dissipation member
220 Image scanning unit
220a First image scanning unit
220b Second image scanning unit
221 Light source
222 Condenser lens array
223 Housing
224 Reference white plate
230 Scanning unit
26 Secondary transfer device
26a Transfer roller
300 Document conveyor
301 Document detector
301a First document detector (example of document detector)
301b Second document detector (another example of document detector)
400 Image scanning device
70 Controller
71 Processor
72 Storage
D Conveying direction
G Document G1 leading edge G2 trailing edge
L1 First upstream conveying distance
L2 First downstream side conveying distance
L3 Second upstream conveying distance
L4 second downstream side conveying distance
P1 Power supply controller
P2 First scanning controller
P3 Second scanning controller
R1 First image scanning position (example of image scanning position)
R2 Second image scanning position (another example of image scanning position)
R3 Standby position
R4 Shading position
R5 Start position
S Document conveyance path
X Main scanning direction
Y Sub-scanning direction
Y1 First side
Y2 Second side
α Scanning element region
β Scanning element corresponding region
βa Electronic component placement location
βb Region other than electronic component placement location

1. An image scanning device comprising:
an image scanning sensor including a substrate provided with a plurality of scanning elements and electronic components provided, the image scanning device conveying a document to be scanned by the image scanning sensor toward an image scanning position, and scanning the document conveyed to the image scanning position by the image scanning sensor; and
a power supply controller that controls supply of power to the electronic component in the image scanning sensor, wherein
when scanning the document, the image scanning device
conveys the document toward the image scanning position in a power supply stop state in which power supply to the electronic component is stopped by the power supply controller,
sets a power supply state in which power is supplied to the electronic component by the power supply controller before scanning the document at the image scanning position,
scans the document at the image scanning position in the power supply state, and
sets the power supply stop state after scanning the document at the image scanning position.

2. The image scanning device according to claim 1, wherein
when scanning a first document, the image scanning device
sets the power supply state and executes shading correction in the power supply state, and
scans the first document at the image scanning position after executing the shading correction, and
sets the power supply stop state after scanning the first document at the image scanning position.

3. The image scanning device according to claim 2, wherein
the image scanning device performs a conveying process of conveying the first document to the image scanning position and a correction process of executing the shading correction in parallel.

4. The image scanning device according to claim 1, wherein
the image scanning device
sets the power supply state when the image scanning device is started up and performs the shading correction in the power supply state, and
sets the power supply stop state after executing the shading correction.

5. The image scanning device according to claim 1, wherein
the image scanning device sets the power supply state or the power supply stop state based on timing detection before scanning the document at the image scanning position and timing detection after scanning the document at the image scanning position, the timing detections being detected using a document detector provided in the document conveyance path where the document is conveyed.

6. The image scanning device according to claim 1, wherein
the image scanning sensor is a contact image sensor having a scanning element region that is a region where the plurality of scanning elements are arranged side by side in a main scanning direction on a scanning element placement side surface of the substrate on which the plurality of scanning elements are disposed.

7. The image scanning device according to claim 6, wherein
the electronic component is provided on a scanning element corresponding region corresponding to the scanning element region on an opposite surface opposite to the scanning element placement side surface of the substrate in the image scanning sensor or at a predetermined electronic component placement location near the scanning element corresponding region.

8. The image scanning device according to claim 1, wherein
the electronic component is a semiconductor IC chip.

9. An image forming device comprising:
the image scanning device according to claim 1.
